(19) United States
(12) Patent Application Publication
(10) Pub. No.: US 2017/0114821 A1
(43) Pub. Date: Apr. 27, 2017

(54) HIGH FRACTURE TOUGHNESS CERAMIC SUPPORT NUT PLATE AND GANG CHANNEL

(71) Applicant: The Boeing Company, Chicago, IL (US)

(72) Inventor: Robert A. DiChiara, Carlsbad, CA (US)

(73) Assignee: The Boeing Company, Chicago, IL (US)

(21) Appl. No.: 14/918,899

(22) Filed: Oct. 21, 2015

(51) Int. Cl. F16B 37/04; F16B 39/24

(52) U.S. Cl. CPC F16B 37/045; F16B 39/24

(57) ABSTRACT

A nut plate (10) and a gang channel (78) are constructed of ceramic material. In one version, the nut plate (10) and gang channel (78) are constructed of aluminum oxide ceramic material reinforced with silicon-carbide crystal whiskers. In another version, the nut plate (10) and gang channel (78) are constructed of silicon-nitride. In a third version the nuts (54) are constructed of oxide ceramic material reinforced with silicon-carbide crystal whiskers or silicon-nitride and gage channel (78) are constructed of CMC (either oxide or non-oxide).

### FIELD

This disclosure pertains to a nut plate and gang channel that are constructed of an aluminum oxide (Al₂O₃) ceramic material reinforced with silicon-carbide (SiC) crystal whiskers. In an alternate construction, the nut plate and gang channel are constructed of silicon-nitride (Si₃N₄).

### BACKGROUND

Thermal protection systems (TPS), for example re-entry heat shields for spacecraft, fuselage sections of hypersonic vehicles, jet engine exhaust components, etc. are constructed of materials that need to be heat-resistant and must endure very harsh environments. Reentry vehicle surfaces are particularly difficult. The surface must have low catalycity because the shockwave just in front of the reentry vehicle surface disassociates the air molecules and provides the potential for additional heating. As the air molecules break apart and collided with the surface they recombine in an exothermic reaction. Since the surface acts as a catalyst, it is important that the surface has a low catalycity, this will reduce the propensity to augment the energy from this chemical reaction. These materials must also be resistant to hot oxygen, particularly resistant to atomic oxygen to minimalize scaling of the material surfaces. The materials must have high emissivity to ensure the maximum rejection of incoming convective heat through radiative heat transfer. These requirements are difficult to meet in thermal protection system applications such as tiles, blankets and other similar structures used in the thermal protection systems.

In thermal protection systems that employ tiles, blankets and ceramic matrix composite components, the tiles for example are primarily bonded in place. For many TPS applications, adhesively bonding insulation such as tiles is used to attach insulation to the outer mold lines of vehicles, for example hypersonic vehicles. There is an interest in mechanically attaching tiles, blankets and other forms of ceramic matrix composites for easy, quick replacements, or for maintenance, as well as the limitation in temperature of many adhesives.

However, in applications such as heat shield surfaces of re-entry vehicles, engine exhaust components and in hypersonic vehicle constructions, the use of metal nut plates and metal gang channels in attaching ceramic matrix components in these applications has been a problem. Most metals have high catalycity, low thermal emissivity, a high coefficient of thermal expansion and get soft and weaker with increases in temperature. If nut plates and gang channels are used to attach TPS or exhaust liners to a vehicle, they are usually made of high temperature metal alloys. Presently, most turbine engine exhaust components, nut plates and gang channels are mainly if not all made out of super alloy metals. The components are actively cooled so that the metal can survive the environment. As ceramic matrix composites and other ceramic components get implemented into turbine engine exhaust systems, the metal super alloy nut plates and gang channels can no longer be used because the metal cannot take the temperature. This is made worse by the ceramic matrix composite having a lower thermal conductivity compared to metal, so even if the panels were cooled, the nut plates and gang channels would still have a tendency to overheat.

### SUMMARY

For the above set forth reasons and others, it would be much better for a nut plate or a gang channel used to fasten ceramic matrix composites in a thermal protection system to be constructed of a ceramic material. However, most strong ceramics are monolithic, brittle, notch sensitive, have thermal shock issues and are prone to catastrophic failure, which is not ideal for making nut plates and gang channels. Because ceramics in a nut plate or in a nut of a gang channel are brittle, hard and notch sensitive, machining internal screw threads of ceramic material is very difficult. Creating threaded ceramic fasteners is usually done in processes like injection molding before firing, but these types of threads are rounded and not precise due to firing shrinkage, and the ceramic fastener strength is still typically very low, with high scatter, and are not very predictable.

The high fracture toughness ceramic support nut plate and gang channel nuts of this disclosure are constructed of an aluminum oxide ceramic material reinforced with crystal whiskers. In alternate embodiments the nut plate and gang channel nuts are constructed of silicon-nitride. The nut plate and gang channel nuts meet the requirements of high strength over the entire temperature range in which they will be exposed, with high fracture toughness, minimal notch sensitivity, low catalycity, high thermal emissivity, high stiffness, high hardness, good thermal shock resistance and not scaling by hot atomic oxygen. Ceramics including alumina are naturally low in catalycity, the opposite of most metals. The crystal whiskers mixed with the aluminum oxide not only improve fracture toughness, but also increase the emissivity of the nut plate and gang channel nuts. Again, the opposite of metal which has very low emissivity and high catalycity. The aluminum oxide ceramic material reinforced with the crystal whiskers also has a coefficient of thermal expansion that closely matches the coefficient of thermal expansion of oxide ceramic matrix components with which the nut plate is used and with which the gang channel nuts is used.

In constructing the nut plate and the nuts of the gang channel, a mixture of an aluminum oxide ceramic material powder and crystal whiskers is prepared. In alternative constructions, silicon-nitride is used. The crystal whiskers are silicon-carbide crystal whiskers. The mixture is then hot pressed at a high temperature to form the nut plate. The nuts of the gang channel are prepared in the same manner. To form the internal screw threads in the bolt holes of the nut plate and in the nuts of the gang channel, graphite pre-forms are machined with external screw threads. The external screw threads are complementary to the internal screw threads of the bolt holes in the nut plate and the internal screw threads of the nuts of the gang channel. The pre-forms are placed inside the powder mixture of the aluminum oxide ceramic material powder and the crystal whiskers so that during compaction and heating of the mixture, the internal threads of the bolt holes in the nut plate and the internal threads of the nuts of the gang channel are formed around the graphite pre-forms. After the hot pressing of the mixture forming the nut plate and the nuts of the gang channel is completed, the much softer graphite pre-forms are cleaned out of the bolt holes of the nut plate and out of the nuts of the gang channel, leaving internal female screw threads in the bolt holes of the nut plate and in the nuts of the gang channel to exact dimensions. Since the internal screw threads were formed under pressure during sintering, the shrinkage normally associated with firing ceramics is eliminated.

In constructing the channel member of the gang channel, a ceramic matrix composite material is used.

The nut plate is used to secure together adjacent components, for example ceramic matrix composite panels by aligning fastener holes of the composite panels with the internal screw threaded holes formed in the nut plate. External screw threaded fasteners are then inserted through the aligned holes of the composite panels and the nut plate. Screw threading the fasteners through the holes of the composite panels and into the internal screw threaded holes of the nut plate secure the composite panels together.

In use of the gang channel to secure components together, for example ceramic matrix composite components, the internal screw threaded nuts are positioned in the channel member of the gang channel in a conventional manner. The gang channel is then used in a conventional manner to secure together two components.

The features, functions and advantages that have been discussed can be achieved independently in various embodiments or may be combined in yet other embodiments, further details of which can be seen with reference to the following description and drawings.

### BRIEF DESCRIPTION OF THE DRAWINGS

FIG. 1 is a representation of a plan view of the nut plate of this disclosure.

FIG. 2 is an end elevation view of the nut plate of FIG. 1.

FIG. 3 is a side elevation view of the nut plate of FIG. 1.

FIG. 4 is a representation of a method of constructing the nut plate of this disclosure.

FIG. 5 is a representation of a plain view of the nut plate of this disclosure used to secure together two components.

FIG. 6 is a representation of an end view of the nut plate of FIG. 5.

FIG. 7 is a representation of an end view of two nut plates used to secure two components together.

FIG. 8 is a representation of a perspective view of the nut and channel member of the gang channel of this disclosure.

FIG. 9 is a representation of the method of constructing the nut of the gang channel of this disclosure.

FIG. 10 is a representation of the nut and the channel member of the gang channel of this disclosure assembled together.

### DESCRIPTION

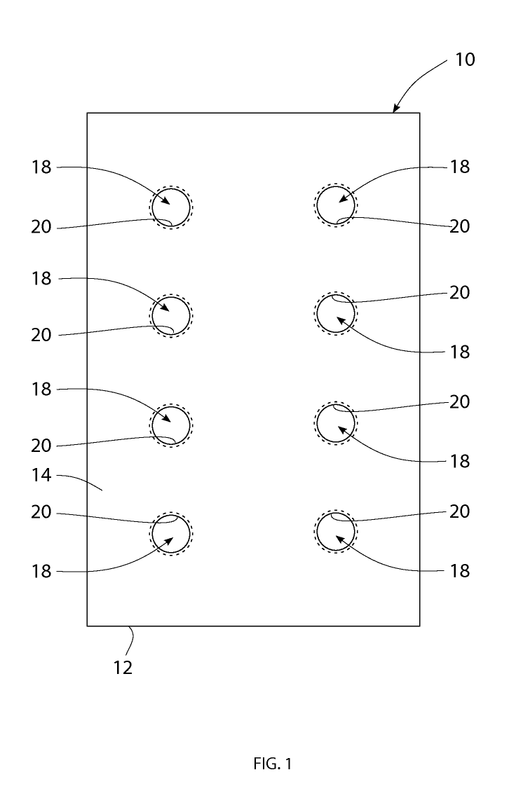

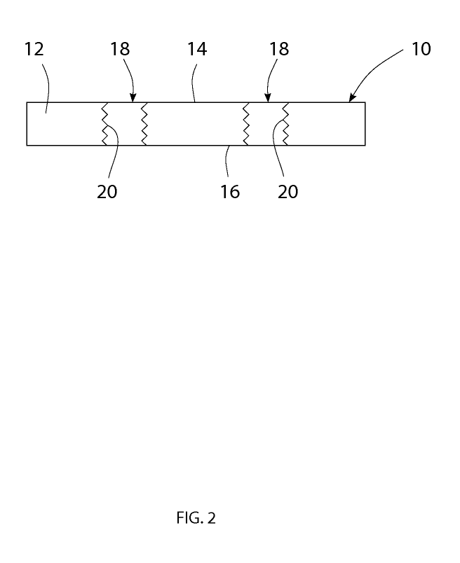

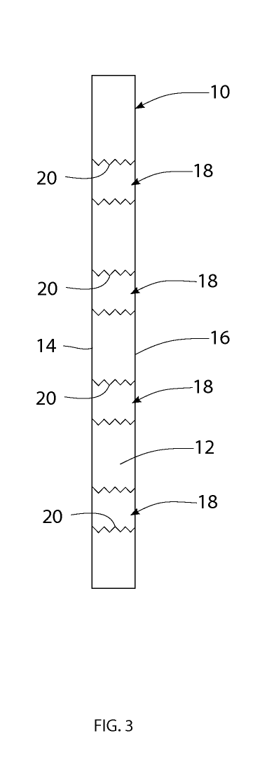

FIG. 1 is a representation of a plan view of the nut plate (10) of this disclosure. FIG. 2 is a representation of an end view of the nut plate (10). The opposite end of the nut plate (10) is a mirror image of the end of the nut plate represented in FIG. 2. FIG. 3 is a representation of a side view of the nut plate (10). The opposite side of the nut plate (10) is a mirror image of the side of the nut plate represented in FIG. 3. As represented in FIGS. 1-3, the configuration of the nut plate (10) is conventional.

The nut plate (10) has a generally rectangular configuration defined by a peripheral edge (12) of the nut plate (10). The nut plate (10) has a flat, smooth front surface (14) and an opposite, flat, smooth back surface (16). The nut plate (10) has a plurality of cylindrical interior bores or fastener holes (18) that pass through the nut plate. Each of the interior bores (18) has a screw threaded interior surface (20) surrounding the interior bore. In FIG. 1, the nut plate (10) is represented with eight interior bores (18) and eight interior screw threaded surfaces (20). It should be understood that the eight interior bores (18) represented in FIG. 1 is only one example of the number of interior bores (18) that could be provided in the nut plate (10).

The nut plate (10) represented in FIGS. 1-3 is unique in that it is constructed as a high temperature nut plate. This is achieved by the nut plate (10) being constructed of a ceramic composite that uses the technology of whisker reinforcement. The hard ceramic matrix is reinforced with extremely strong, stiff crystals, commonly called whiskers. The nut plate (10) is constructed of a ceramic matrix composite material that is a mixture of aluminum-oxide ceramic material powder reinforced with silicon-carbide crystal whiskers. One example of a ceramic matrix composite material used to construct the nut plate (10) is the whisker reinforced ceramic material WG-300®, which is a registered trademark of Greenleaf Corporation. In WG-300®, the percentage of silicon-carbide crystal whiskers in the mixture of aluminum oxide ceramic material powder and the silicon-carbide crystal whiskers is approximately 30%. In other examples of the ceramic composite material used to construct the nut plate (10), the percentage of silicon-carbide crystal whiskers in the mixture of aluminum oxide ceramic material powder and the silicon-carbide crystal whiskers is in a range of 18%-30% of the mixture.

In alternate embodiments of the nut plate (10), the nut plate is constructed of the ceramic material silicon-nitride.

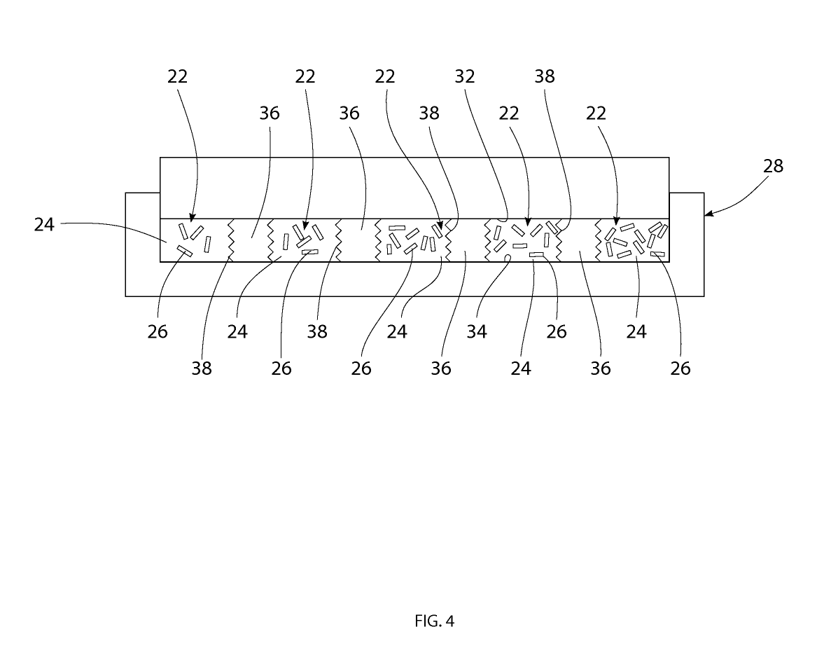

The method of constructing the nut plate (10) is represented in FIG. 4. In the construction of the nut plate (10), a mixture (22) of aluminum oxide ceramic material powder (24) and the silicon-carbide crystal whiskers (26) is prepared. The mixture (22) of the aluminum oxide ceramic material powder (24) and the silicon-carbide crystal whiskers (26) is put into a high temperature, high pressure press (28) for forming the nut plate (10). FIG. 4 shows a representation of a high temperature, high pressure press (28). In FIG. 4, the aluminum oxide ceramic material powder (24) and the silicon-carbide crystal whiskers (26) are represented schematically and are not shown to scale. The press (28) has mold die pieces (32), (34) that are configured to form the nut plate (10) from the aluminum oxide ceramic material powder (24) and the silicon-carbide crystal whiskers (26) of the mixture (22). The mixture (22) is positioned in the press (28) between the press die pieces (32), (34) and is hot pressed at a temperature of over 3,000 degrees Fahrenheit, while the mixture (22) is compressed at a high pressure to form the nut plate (10). The nut plate (10) is dense and has a fine grain size. External pressure applied to the mixture (22) simultaneously with the temperature of the press (28) produces a good consolidation of the aluminum oxide ceramic material powder (24) and the reinforcing silicon-carbide crystal whiskers (26). The aluminum oxide ceramic material and the reinforcing silicon-carbide crystal whiskers of the mixture (22) produce the nut plate (10) of hard ceramic material with high fracture toughness.

In developing the method of forming interior bores (18) with internal screw threaded surfaces (20) in the nut plate (10), it was recognized that it would be very difficult, if not impossible to machine internal screw threads in the very hard ceramic material of the nut plate (10), at least cost-efficiently. To form the screw threaded interior surfaces (20) in the nut plate (10), graphite pre-forms or inserts (36) are machined with external screw threads (38) that are complementary to the screw threaded interior surfaces (20) of the nut plate (10). As represented in FIG. 4, the pre-forms (36) are placed inside the mixture (22) in the press (28). The pre-forms (36) are positioned at the desired positions of the screw threaded interior surfaces (20) of the interior bores (18). During heating and compression of the mixture (22) in the press (28) into the dense, finished ceramic nut plate (10), the screw threaded interior surfaces (20) of the nut plate (10) are formed around the graphite pre-forms (36). After the hot pressing of the mixture (22) forming the nut plate (10) is completed, the soft graphite pre-forms (36) having the external screw threaded surfaces (38) are easily cleaned out of the nut plate (10), leaving cost efficient, clean, precise screw threaded interior surfaces (20) in the nut plate (10). Because the screw threaded interior surfaces (20) are formed during the pressure sintering around the pre-forms (36), no shrinkage of the screw threaded interior surfaces (20) occurs. This enables the production of high tolerance screw threaded interior surfaces (20) that match closely to screw threaded exterior surfaces on mating fastener bolts.

In an alternate nut plate construction, silicon-nitride is used in place of the mixture of aluminum oxide ceramic material powder and the silicon-carbide crystal whiskers. Other than this change, the method of constructing the nut plate (10) is the same and the nut plate (10) constructed according to the method is the same.

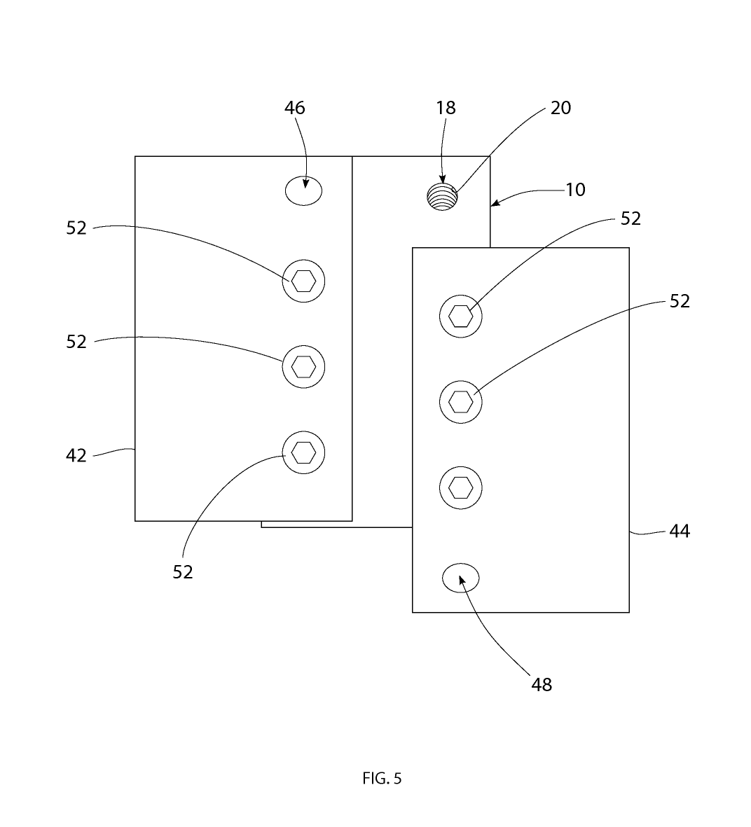

FIG. 5 is a representation of the nut plate (10) used to connect two ceramic matrix composite components (42), (44) together. In the representation of FIG. 5 the ceramic matrix composite components (42), (44) are panels. In connecting the panels (42), (44) together, the panels are provided with interior bores or fastener holes (46), (48) that are positioned through the panels at positions that correspond to the positions of the screw threaded interior surfaces (20) of the nut plate (10). A plurality of fasteners or bolts (52) as represented in FIG. 5 are then inserted through the panel bores (46), (48) and screwed into the screw threaded interior surfaces (20) of the nut plate (10). The bolts (52) could be constructed as conventional metal bolts, or could also be constructed of the mixture of aluminum oxide ceramic material powder and the silicon-carbide crystal whiskers, or of silicon-nitride.

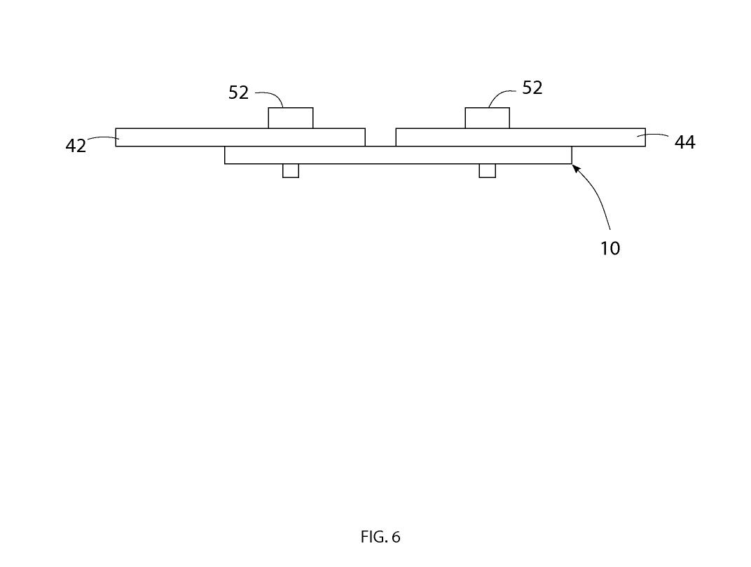

FIG. 6 is a representation of an end view of the nut plate (10), the panels (42), (44) and the bolts (52) represented in FIG. 5.

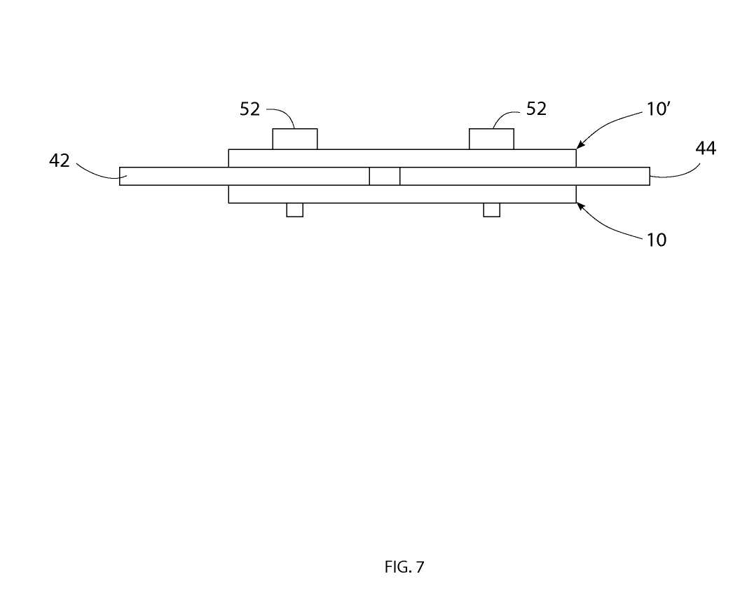

FIG. 7 is a representation similar to that of FIG. 6, but showing two nut plate (10) and one top cover plate with just through holes (no threads) (10′) securing the panels (42), (44) together on opposite sides of the panels.

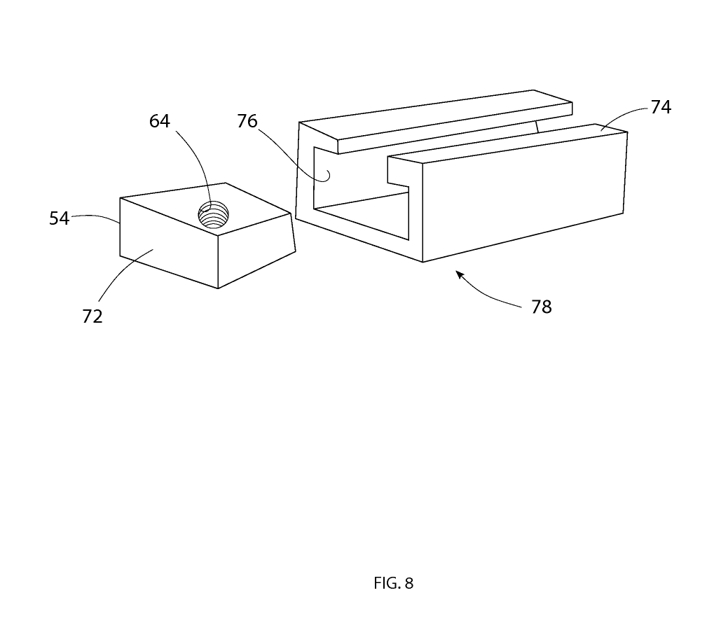

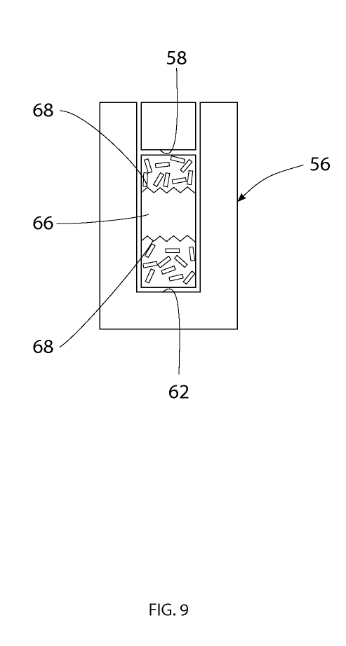

FIG. 8 is a representation of one of the nuts (54) used in the gang channel of this disclosure. The method of constructing the nut (54) is similar to that of the nut plate (10) and is represented in FIG. 9. In the construction of the nut (54), the mixture (22) of the aluminum oxide ceramic material powder (24) and the silicon-carbide crystal whiskers (26) is prepared. The mixture (22) is put into a high temperature, high pressure press (56) for forming a blank to be used in constructing the nut (54). In FIG. 9 the aluminum oxide ceramic material powder (24) and the silicon-carbide crystal whiskers (26) are represented schematically and are not shown to scale. The press (56) has mold die pieces (58), (62) that are configured to form a blank for the nut (54) from the aluminum oxide ceramic material powder and the silicon-carbide crystal whiskers of the mixture (22). The mixture (22) is positioned in the press (56) between the press die pieces (58), (62) and is hot pressed at a temperature of over 3,000 degrees Fahrenheit while the mixture is compressed at a high pressure to form a blank of the nut (54). The blank of the nut (54) is dense and has a fine grain size. External pressure applied to the mixture (22) simultaneously with the temperature of the press (56) produces a good consolidation of the aluminum oxide ceramic material and the reinforcing silicon-carbide crystal whiskers. The aluminum oxide ceramic material and the reinforcing silicon-carbide crystal whiskers produce the blank of the nut (54) of hard ceramic material with high fracture toughness.

To form the screw threaded interior surface (64) in the nut (54), again a graphite pre-form insert (66) is machined with external screw threads (68) that are complementary to the screw threaded interior surface (64) of the nut (54). As represented in FIG. 9, the pre-form (66) is placed inside the mixture (22) in the press (56). During heating and compression of the mixture (22) in the press (56) into the dense, finished ceramic blank of the nut (54), the screw threaded interior surface (64) of the nut (54) is formed around the graphite pre-form (66). After the hot pressing of the mixture (22) forming the blank of the nut (54) is completed, the soft graphite pre-form (66) having the external screw thread (68) is easily cleaned out of the nut (54), leaving a cost-efficient, clean, precise screw threaded interior surface (64) in the nut (54). Because the screw threaded interior surface (64) is formed during the pressure sintering around the pre-form (66), no shrinkage of the screw threaded interior surface (64) occurs. This enables the production of a high tolerance screw threaded interior surface (64) that matches closely to a screw threaded exterior surface of a mating fastener bolt.

A channel interface surface, for example the hex shaped exterior surface (72) of the nut (54) can then be machined on the nut (54). Alternatively, the channel interface surface (72) could be molded on the nut (54).

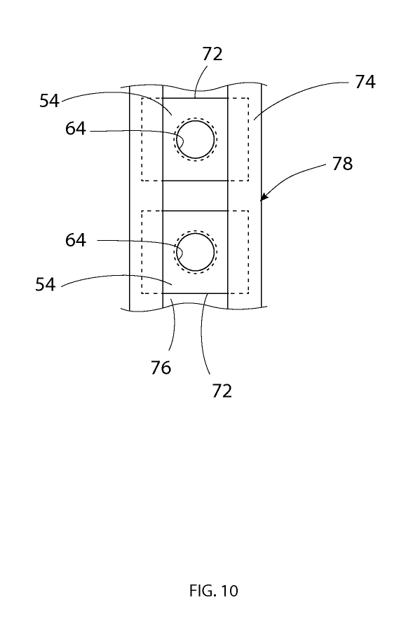

FIG. 8 is a representation of a perspective view of the nut (54) and an end of the channel (74) with which the nut is used. The channel (74) is constructed of ceramic matrix composite (CMC) material, such as oxide CMC or non-oxide CMC, but could be constructed of other equivalent types of materials. Nuts and fasteners of SiC whisker reinforced alumina would most likely be used with gang channels made out of oxide CMC which would typically be used on supporting oxide CMC composites joints since the Coefficient of Thermal Expansion (CTE) are similar, whereas the Si₃N₄ nuts and fasteners would most likely be used with non-oxide CMC like SiC/SiC or C/SiC since the CTE are also similar but much lower. As example the SiC whisker reinforced alumina for the nuts and the fasteners from Greenleaf such as made out of WG-100, WG-150 or WG-300 range (with various SiC whisker reinforcement from 10-30%) has CTE ranging from 7.2×10⁻⁶/C to 6.0×10⁻⁶/C and would be used with oxide CMC gang channels to support oxide CMC panel joints. The oxide CMC has a CTE ranges from 4.6-7.9×10⁻⁶/C depending on fibers used (Nextel-312, Nextel-720 or Nextel-610 from 3M Corporation) with the typical range of 6-7.9×10⁻⁶/C for the higher temperature oxide CMC using 3M's oxide fibers such as Nextel-720 and Nextel-610. In the case of using nuts and joints fabricated out of Si₃N₄ which has a CTE ranging from 3.0-3.8×10⁻⁶/C these type of materials would be used with non-oxide composites and gang channels constructed of composites like SiC/SiC or C/SiC having CTE in the range of 3.0-5×10⁻⁶/C. The channel interface surface (72) of the nut (54) is dimensioned to fit in sliding engagement in the interior channel (76) of the channel member (74) in a conventional manner in producing the gang channel (78) represented in FIG. 10. One or more nuts (54) can be inserted into the interior channel (76) in constructing the gang channel (78). The design of this type of ceramic gang channel allows the CMC channel to hold the individual ceramic threaded nuts in place, but permits the nuts to both slide in the channel as well as float. This helps account for tolerances and misalignment. The nuts act as individual entities while being held in place and allowing for only one side access to tighten the bolts when fastening components.

As various modifications could be made in the construction of the apparatus and its method of operation herein described and illustrated without departing from the scope of the invention, it is intended that all matter contained in the foregoing description or shown in the accompanying drawings shall be interpreted as illustrative rather than limiting. Thus, the breadth and scope of the present disclosure should not be limited by any of the above described exemplary embodiments, but should be defined only in accordance with the following claims appended hereto and their equivalents.

What is claimed:

1. A nut plate (10) comprising:
the nut plate (10) late being constructed of a ceramic material; and,
a plurality of screw threaded interior surfaces (20) in the nut plate.

2. The nut plate (10) of claim 1, further comprising:
the ceramic material being a mixture of an aluminum oxide powder (24) reinforced with crystal whiskers (26) in the aluminum oxide ceramic material.

3. The nut plate (10) of claim 2, further comprising:
the crystal whiskers (26) being silicon-carbide crystal whiskers.

4. The nut plate (10) of claim 1, further comprising:
the ceramic material being silicon-nitride.

5. The nut plate (10) of claim 3, further comprising:
a plurality of bolts (52), each bolt of the plurality of bolts (52) being screw threaded into a screw threaded interior surface (20) of the plurality of screw threaded interior surfaces (20) in the nut plate (10).

6. The nut plate (10) of claim 5, further comprising:
each bolt (52) is constructed of a mixture of aluminum oxide ceramic material reinforced with silicon-carbide crystal whiskers.

7. The nut plate (10) of claim 5, further comprising:
a first ceramic matrix composite component (42);
a second ceramic matrix composite component (44); and,
the first ceramic matrix composite component (42) and the second ceramic matrix composite component (44) being secured to the nut plate (10) by the plurality of bolts (52).

8. The nut plate (10) of claim 4, further comprising:
a plurality of bolts (52), each bolt of the plurality of bolts (52) being screw threaded into a screw threaded interior surface (20) of the plurality of screw threaded interior surfaces (20) in the nut plate (10).

9. The nut plate of claim 8, further comprising:
a first ceramic matrix composite component (42);
a second ceramic matrix composite component (44); and, the first ceramic matrix composite component (42) and the second ceramic matrix composite component (44) being secured to the nut plate (10) by the plurality of bolts (52).

10. A method of securing components together comprising:
constructing a nut plate (10) of a ceramic material powder (24);
providing a plurality of fastener holes (18) in the nut plate (10);
providing a first component (42) with fastener holes (46);
providing a second component (44) with fastener holes (48);
positioning the first component (42) adjacent the nut plate (10) and aligning the fastener holes (46) of the first component (42) with fastener holes (18) of the nut plate (10);
positioning the second component (44) adjacent the nut plate (10) and aligning fastener holes (48) of the second component (44) with fastener holes (18) of the nut plate (10); and,
inserting fasteners (52) through the aligned fastener holes (46) of the first component (42) and the fastener holes (18) of the nut plate (10) and inserting fasteners (52) through the fastener holes (48) of the second component (44) aligned with the fastener holes (18) of the nut plate (10).

11. The method of claim 10, further comprising:
forming the fastener holes (18) in the nut plate (10) by positioning inserts (36) inside the ceramic material powder (24) at positions of the fastener holes (18);
simultaneously heating and pressurizing the ceramic material powder (24) creating the nut plate (10); and,
removing the inserts (36) from the nut plate (10) creating screw threaded interior surfaces (20) inside the nut plate (10).

12. The method of claim 11, further comprising:
using a mixture of aluminum oxide ceramic material and silicon-carbide crystal whiskers as the ceramic material powder (24).

13. The method of claim 11, further comprising:
using silicon-nitride as the ceramic material powder.

14. A gang channel (78) comprising:
a channel member (74); and,
a nut (54) in the channel member (74), the nut being constructed of a ceramic material (24).

15. The gang channel (78) of claim 14, further comprising;
the channel member (74) being constructed of ceramic matrix composite material, such as an oxide CMC or non-oxide CMC like SiC/SiC.

16. The gang channel (78) of claim 14, further comprising:
the nut (54) being one of a plurality of nuts (54) in the channel member (74).

17. The gang channel (78) of claim 14, further comprising:
the ceramic material being a mixture of an aluminum oxide ceramic material (24) reinforced with crystal whiskers (26) in the aluminum oxide ceramic material.

18. The gang channel (78) of claim 17, further comprising:
the crystal whiskers (26) being silicon-carbide crystal whiskers,

19. The gang channel (78) of claim 14, further comprising:
the ceramic material being silicon-nitride.

20. The gang channel (78) of claim 14, further comprising:
the nut (54) being one of a plurality of nuts (54) in the channel member (74);
each nut (54) of the plurality of nuts (54) fitting in sliding engagement in the channel member (74); and,
each nut (54) of the plurality of nuts (54) being secured against rotation inside the channel member (74).
